(19) United States
(12) Patent Application Publication
(10) Pub. No.: US 2004/0210664 A1
(43) Pub. Date: Oct. 21, 2004

(54) System and method for transmitting data

(75) Inventor: Francis T. Prendergast, Windham, NH (US)

Correspondence Address: SQUARE D COMPANY, INTELLECTUAL PROPERTY DEPARTMENT, 1415 SOUTH ROSELLE ROAD, PALATINE, IL, 60067, US

(73) Assignee: Schneider Automation Inc.

(21) Appl. No.: 10/417,685

(22) Filed: Apr. 17, 2003

(51) Int. Cl. G06F 15/16

(52) U.S. Cl. 709/230

(57) ABSTRACT

The disclosure presents a system and method for transmitting data from Programmable Logic Controllers (PLCs). The system may be implemented in a variety of ways, including as a method for transmitting data between a first and a second programmable logic controller, the method comprising the steps of: inputting data into a first register of a first programmable logic controller; inputting the data to a first management information table; transmitting the data from the first programmable logic controller to an external network; inputting the data from the external network into a second programmable logic controller; inputting the data into a second management information table; and, introducing the data into a second register of the second programmable logic controller.

### TECHNICAL FIELD

This invention relates generally to a system and method for transmitting data from Programmable Logic Controllers (PLCs). More particularly, the present invention relates to a system and method for improved transmission of data between PLCs using a Simple Network Management Protocol.

### BACKGROUND OF THE INVENTION

Industrial control systems often include control devices such as a Programmable Logic Controllers (PLC). A PLC is a device that controls another device by receiving inputs, acting on the inputs according to a programmable set of instructions, and generating outputs for controlling another device. PLCs have become an integral part of industrial automation.

PLCs may coordinate interaction among connected input and output modules on a communication bus. Typically, the controller monitors the modules and facilitates actions within the control system. PLCs provide a replacement for hard-wired relay and timer logic circuits found in traditional control panels. PLCs offer flexibility in process control since their behavior may be based on executing simple programmed logical instructions. PLC installation is generally easier than relay and logic circuits, and changes to the instructions makes alterations to the control system easier to implement. Most modem PLCs offer internal functions such as timers, counters, shift registers, and special functions making sophisticated control possible using even the most modest PLC.

PLC input and output modules include sensors, relays, gauges, valves, message displays, switches, limit switches, proximity switches, motor starters, motor controllers, and other like devices as well as traditional Input/Output (I/O) modules for control systems. The input module monitors, or senses, a condition. A signal representing the condition is received by the input module and transmitted to the PLC for processing. The PLC utilizes the representative signal according to a specific function. Generally, the function requires the PLC to perform an operation related to the signal and transmit the result of the operation to the appropriate output module. In this way, the PLC may monitor inputs of a process under control and possibly from the network. Based on the program being executed in memory, the PLC may energize appropriate outputs. The control operating system, which controls the behavior of the PLC, can be modified permitting the entire operation of the external hardware to be altered without the need to disconnect or reroute wiring. Modern PLCs have the ability to communicate with networks. A user may now monitor and control PLCs from a remote location. Large industrial automation applications take advantage of this ability to centrally manage automation applications.

Simple Network Management Protocol (SNMP) is a familiar communication protocol used in networks such as Ethernet networks. Ethernet networks often use SNMP to acquire information used to manage the network. SNMP is often used to acquire network performance data. This data allows the network to efficiently allocate resources within the network.

Using SNMP, a network manager may issue queries to individually identifiable network devices. The network devices then provide the network manager with the requested data. The network devices store network information and device status information. Management Information Bases (MIBs) may describe the network information and status information stored by the network devices. The network manager may continuously access management data by continuously or repeatedly polling the network devices. The network manager may also direct the network devices to provide information when certain conditions are met. Requesting the network devices only send information when certain conditions are met may desirably result in reduced network traffic compared to requesting data using polling techniques.

PLCs often include data registers that record management information regarding the operation of the PLC and the devices associated with the PLC. The PLC uses the data registers to efficiently allocate resources within the PLC and the network associated with the PLC. PLC network administrators use many different communication protocols tailored to the components of the particular PLC network. The different communication protocols are often associated with manufacturers of the network devices. The PLC network administrators gather information from the network devices such as, but not limited to, communication ports in use, data speed, error rates, and power supply status.

PLC network administrators currently use management software that incorporates the communication protocol of the managed network. The management software currently cannot communicate efficiently with PLC registers employing different management software incorporating a different communication protocol. As the size of the automation application increases, so does the need for communication between PLCs. There are common systems to assist in coordinating communication between PLCs operating with the same network communication protocols. There are also common systems for communicating between PLCs that are operating with diverse network communication protocols, wherein direct communication between the differing network protocols is not possible. However, the known systems for communicating between PLCs that are using diverse communication protocols generally require expensive communication bridges to translate between the network communication protocols. The industry is in need of more efficient systems and methods for transmitting data between Programmable Logic Controllers (PLCs) and other network devices.

### SUMMARY OF THE INVENTION

The present invention provides a system and method for transmitting data from Programmable Logic Controllers (PLCs). The system may be implemented in a variety of ways, including as a method for transmitting data between a first and a second programmable logic controller, the method comprising the steps of: Inputting data into a first register of a first programmable logic controller; Inputting the data to a first management information table; Transmitting the data from the first programmable logic controller to an external network; Inputting the data from the external network into a second programmable logic controller; Inputting the data into a second management information table; and introducing the data into a second register of the second programmable logic controller.

The data input into the first register is configured in a first network protocol. The first network protocol is associated with the communication protocol of a first internal network. The first management information table is configured to translate the first network protocol to a simple network management protocol. The second management information table is configured to translate the simple network management protocol to a second network protocol. And, the second network protocol is associated with the communication protocol of the second internal network.

Other systems, methods, features, and advantages of the present invention will be, or will become, apparent to one having ordinary skill in the art upon examination of the following drawings and detailed description. It is intended that all such additional systems, methods, features, and advantages included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a graphical representation of a system network including a first Programmable Logic Controller (PLC), a second PLC, and a personal computer, all in communication via an external network. The system network includes an implementation of a data transmission system.

FIG. 2 is a block diagram of a computer. The computer may be the first PLC, the second PLC, the personal computer, and/or a computer included in any number of other subsystems that communicate via the external network of FIG. 1. Computer 200 includes a computer readable medium implementation of the data transmission system.

FIG. 3 is a flowchart showing a first exemplar embodiment of the data transmission system of FIG. 2.

FIG. 4 is a flowchart showing a second exemplar embodiment of the data transmission system of FIG. 2.

FIG. 5 is a flowchart showing a third exemplar embodiment of the data transmission system of FIG. 2.

### DETAILED DESCRIPTION

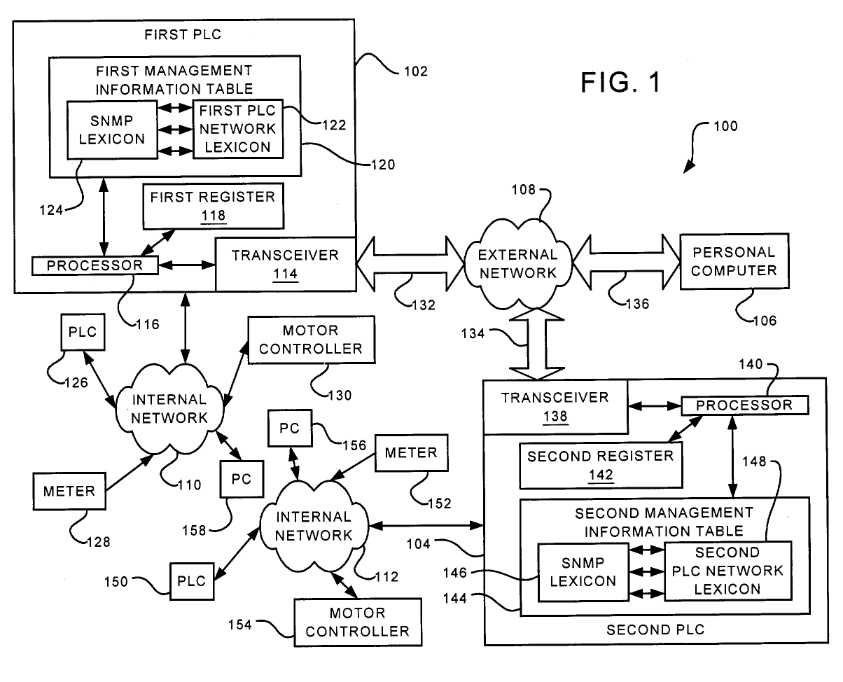

FIG. 1 is graphical representation of a system network 100 including first Programmable Logic Controller (PLC) 102, a second PLC 104, a personal computer 106, all in communication via external network 108. First PLC 102 is associated with first internal network 110 and second PLC 104 is associated with second internal network 112. First PLC 102 includes a transceiver 114, a processor 116, first register 118, and a first management information table 120. In one embodiment, transceiver 114, processor 116, first register 118, and first management information table 120 are in the same housing. Management information table 120 includes a first PLC Network Lexicon 122 and a SNMP Lexicon 124. First management table 120 may include a list of target objects that may contain information desired by the first PLC 102. The list of target objects may be based on information contained in a management information base. The target objects may be associated with Object IDs.

Internal network 110 may be associated with any number of control system devices such as one or more additional PLCs, such as PLC 126, one or more meters, such as meter 128, one or more motor controllers, such as motor controller 130, one or more personal computers, such as personal computer (PC) 158, sensors, relays, gauges, valves, message displays, switches, limit switches, proximity switches, motor starters, trip units, traditional Input/Output (I/O) modules for control systems, and numerous additional devices know to those having ordinary skill in the art. Internal network 110 may employ a commercially available communication protocol such as, but not limited to, Controller Area Network (CAN), Profibus, Interbus, Devicenet, Modbus Plus, Modbus, Fipway, FIPIO, and Ethernet.

External network 108 is in communication with PLC 102 via bus 132. External network 108 is in communication with PLC 104 via bus 134. And, external network 108 is in communication with personal computer 106 via bus 136. External network 108 is configured to transmit information according to Simple Network Management Protocol (SNMP).

Second PLC 104 includes a transceiver 138, a processor 140, second register 142, and second management information table 144. In one embodiment, transceiver 138, processor 140, second register 142, and second management information table 144 are in the same housing. Management information table 144 includes first PLC Network Lexicon 146 and SNMP Lexicon 148. Internal network 112 may be associated with any number of control system devices such as PLC 150, meter 152, motor controller 154, personal computer 156, and numerous additional common control system devices. Internal network 112 may employ a commercially available communication protocol such as, but not limited to, Controller Area Network (CAN), Profibus, Interbus, Devicenet, Modbus Plus, Modbus, Fipway, FIPIO, and Ethernet.

In system network 100, data may be transmitted between the first PLC 102 and the second PLC 104. Data may also be transmitted between the PLCs 102 and 104 and personal computer 106. Data from internal network 110 and/or one of its associated devices, may be transferred to the first PLC 102 using any one of numerous methods known to those having ordinary skill in the art. These numerous methods for communicating may employ communication protocols such as, but not limited to, Controller Area Network (CAN), Profibus, Interbus, Devicenet, Modbus Plus, Modbus, Fipway, FIPIO, and Ethernet. Data from internal network 110 may be input into a first register 118.

First register 118 is a memory element for temporary storage of data processed by PLC 102. In this document and the associated claims, memory elements may be considered to be of a required size to store the expected data. Register 118 may be a single memory element or a series of associated memory elements. In this document, the size or structure of the memory elements making up the register is irrelevant and therefore register 118 may be a memory element of any size or structure.

The data from the internal network 102 is in the first network protocol determined by the communication protocol of the internal network 102. Data from the internal network 102 is stored in the first register 118. Data from internal network 110 may be directed by processor 116 from first register 118 to first management information table 120. First management information table 120 includes a first PLC network Lexicon 122 and a SNMP lexicon 124. First PLC Network Lexicon 122 and SNMP lexicon 124 act together as dictionaries to translate the data in the first communication protocol to data recognizable in the external communication protocol. First PLC network lexicon 122 and a SNMP lexicon 124 may be memory elements configured to work with processor 116 to translate the protocols. Processor 116 may then direct the data to transceiver 114 where the data is transmitted to the external network 108 via bus 132. External network may then transfer the data to second PLC 104. Data from external network 108 may be directed by processor 140 from transceiver 138 to second management information table 144. Second management information table 144 includes a second PLC network Lexicon 148 and SNMP Lexicon 146. Second PLC network lexicon 148 and SNMP Lexicon 146 act together as dictionaries to translate the data in the external communication protocol to data recognizable in the internal communication protocol of the internal network 112. Second PLC network lexicon 148 and a SNMP Lexicon 146 may be memory elements configured to work with processor 140 to translate the protocols.

Data from external network 108 may be directed by processor 140 from second management information table 144 to second register 142. Data from the external network 108 is stored in the second register 142. Second register 142 is a memory element for temporary storage of data processed by PLC 104. Register 142 may be a single memory element or a series of associated memory elements. In this document, the size or structure of the memory elements making up register 142 is irrelevant and therefore register 142 may be a memory element of any size or structure.

Data from external network 108 may then be transferred from second register 142 to internal network 110 and/or one of its associated devices, using any one of numerous methods known to those having ordinary skill in the art. These numerous methods for communicating may employ communication protocols such as, but not limited to, Controller Area Network (CAN), Profibus, Interbus, Devicenet, and Ethernet.

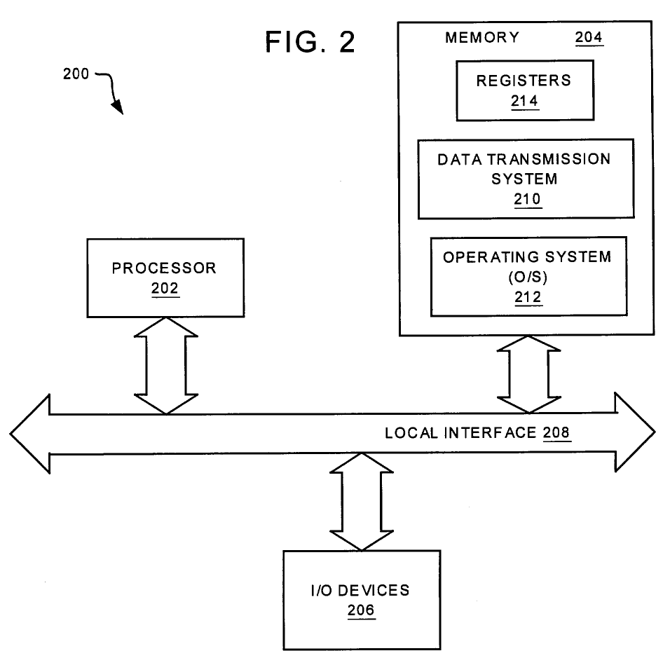

FIG. 2 is a block diagram of a computer 200. Computer 200 may be the first PLC 102, the second PLC 104, personal computer 106, and/or a computer included in any number of other subsystems that communicate via the external network 108. Computer 200 includes a data transmission system 210.

The data transmission system 210 of the invention can be implemented in software, firmware, hardware, or a combination thereof. In one mode, the data transmission system 210 is implemented in software, as an executable program, and is executed by one or more special or general purpose digital computer(s), such as a Programmable Logic Device (PLC), a personal computer (PC; IBM-compatible, Apple-compatible, or otherwise), personal digital assistant, workstation, minicomputer, or mainframe computer. Essentially, any chip that is capable of performing and processing logic or commands can be utilized. Therefore, computer 200 may be representative of any computer in which the data transmission system 210 resides or partially resides.

Generally, in terms of hardware architecture, as shown in FIG. 2, the computer 200 includes a processor 202, memory 204, and one or more input and/or output (I/O) devices 206 (or peripherals) that are communicatively coupled via a local interface 208. Processor 202 may be the processor 116 (FIG. 1), the processor 140 (FIG. 1), a processor of personal computer 106 (FIG. 1), or any processor associated with external network 108 (FIG. 1). The local interface 208 can be, for example, but not limited to, one or more buses or other wired or wireless connections, as is known in the art. The local interface 208 may have additional elements, which are omitted for simplicity, such as controllers, buffers (caches), drivers, repeaters, and receivers, to enable communications. Further, the local interface may include address, control, and/or data connections to enable appropriate communications among the other computer components.

Processor 202 is a hardware device for executing software, particularly software stored in memory 204. Processor 202 can be any custom made or commercially available processor, a central processing unit (CPU), an auxiliary processor among several processors associated with the computer 200, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc., or a 68xxx series microprocessor from Motorola Corporation. Processor 202 may also represent a distributed processing architecture such as, but not limited to, SQL, Smalltalk, APL, KLisp, Snobol, Developer 200, MUMPS/Magic.

Memory 204 can include any one or a combination of volatile memory elements (e.g., random access memory (RAM, such as DRAM, SRAM, SDRAM, etc.)) and nonvolatile memory elements (e.g, ROM, hard drive, tape, CDROM, etc.). Moreover, memory 204 may incorporate electronic, magnetic, optical, and/or other types of storage media. Memory 204 can have a distributed architecture where various components are situated remote from one another, but are still accessed by processor 202.

The software in memory 204 may include one or more separate programs. The separate programs comprise ordered listings of executable instructions for implementing logical functions. In the example of FIG. 2, the software in memory 204 includes the data transmission system 210 in accordance with the present invention, a suitable operating system (O/S) 212, and registers 214. A non-exhaustive list of examples of suitable commercially available operating systems 212 is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Palm Computing, Inc., and Windows CE available from Microsoft Corporation). Operating system 212 essentially controls the execution of other computer programs, such as the data transmission system 210, and provides scheduling, input-output control, file and data management, memory management, and communication control and related services.

The data transmission system 210 may be a source program, executable program (object code), script, or any other entity comprising a set of instructions to be performed. When a source program, the program needs to be translated via a compiler, assembler, interpreter, or the like, which may or may not be included within the memory 204, so as to operate properly in connection with the O/S 212. Furthermore, the data transmission system 210 can be written as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada. In one embodiment, the data transmission system 210 is written in C programming language or Assembler code. As such, in other embodiments of the present invention, the data transmission system 210 can be created using Power Builder.

The I/O devices 206 may include input devices, for example but not limited to, input modules for PLCs, a keyboard, mouse, scanner, microphone, touch screens, interfaces for various medical devices, bar code readers, stylus, laser readers, radio-frequency device readers, etc. Furthermore, the I/O devices 206 may also include output devices, for example but not limited to, output modules for PLCs, a printer, bar code printers, displays, etc. Finally, the I/O devices 206 may further include devices that communicate both inputs and outputs, for instance but not limited to, a modulator/demodulator (modem; for accessing another device, system, or network), a radio frequency (RF) or other transceiver, a telephonic interface, a bridge, a router, transceiver 114 (FIG. 1), transceiver 138 (FIG. 1), etc.

If the computer 200 is a PLC, PC, workstation, PDA, or the like, the software in the memory 204 may further include a basic input output system (BIOS) (not shown in FIG. 2). The BIOS is a set of essential software routines that initialize and test hardware at startup, start the O/S 212, and support the transfer of data among the hardware devices. The BIOS is stored in ROM so that the BIOS can be executed when computer 200 is activated.

When computer 200 is in operation, processor 202 is configured to execute software stored within memory 204, to communicate data to and from memory 204, and to generally control operations of computer 200 pursuant to the software. The data transmission system 210, registers 214, and the O/S 212, in whole or in part, but typically the latter, are read by processor 202, perhaps buffered within the processor 202, and then executed.

When the data transmission system 210 is implemented in software, as is shown in FIG. 2, it should be noted that the data transmission system 210 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The data transmission system 210 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

In another embodiment, where the data transmission system 210 is implemented in hardware, the data transmission system 210 can be implemented with any, or a combination of, the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

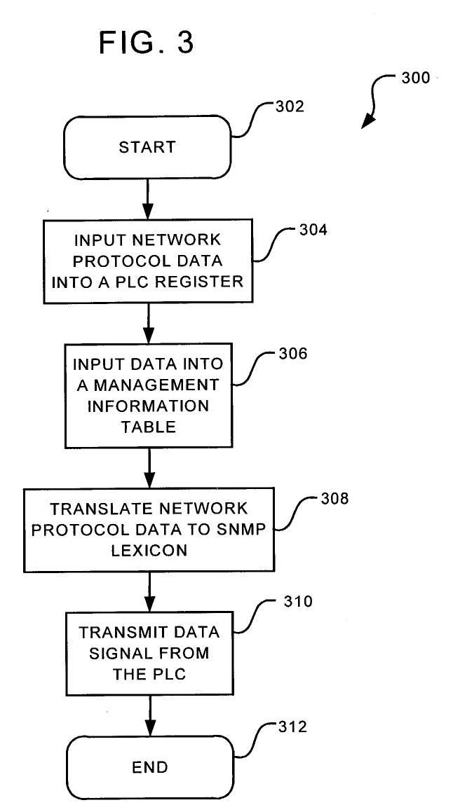

FIG. 3 is a flowchart showing a first exemplar embodiment 300 of the data transmission system 210 of FIG. 2. First exemplar embodiment 300 shows a method for producing a signal for transmitting data from a programmable logic controller, such as PLC 102. The method 300 is called in block 302. In block 304, the method 300 inputs data in into a register, such as register 118. The data is configured in an internal network protocol, such as internal network 110. The internal network protocol is associated with the communication protocol of the internal network, such as internal network 110. The communication protocol of the internal network may be a protocol such as, but not limited to, Controller Area Network (CAN), Profibus, Interbus, Devicenet, Modbus Plus, Modbus, Fipway, FIPIO, and Ethernet. The programmable controller of block 304 may have a housing. The programmable logic controller may also include a processor. After block 304, the method 300 moves to block 306.

In block 306, the method 300 inputs the data into a management information table, such as management information table 120. The management information table is configured to translate the internal network protocol to a simple network management protocol. The housing of the programmable logic controller may also enclose the management information table. The management information table may be configured to translate the internal network protocol to a simple network management protocol by being configured to operate with the processor of the programmable logic controller. After block 306, the method 300 moves to block 308.

In block 308, the method 300 translates the internal network protocol to a simple network management protocol. After block 308, the method 300 moves to block 310.

In block 310, the method 300 transmits a signal from the programmable logic controller to an external network, such as external network 108. The signal includes the data. After block 310, the method 300 moves to block 312 and terminates.

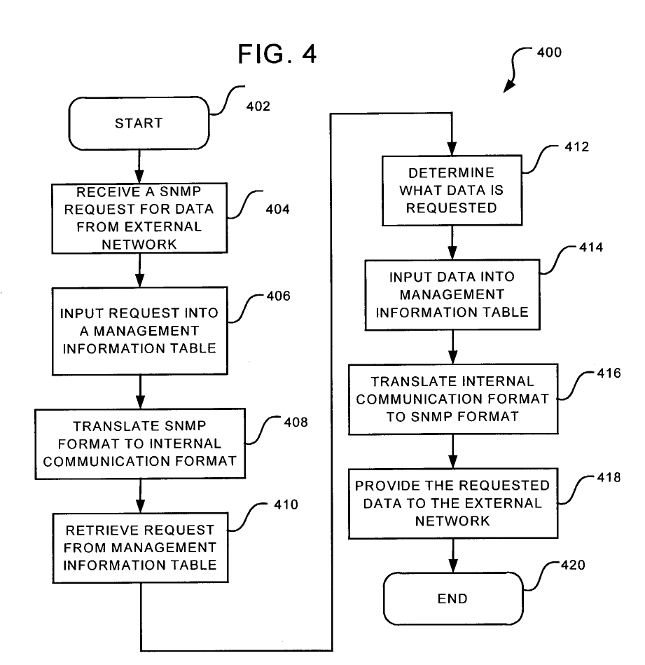

FIG. 4 is a flowchart showing a second exemplar embodiment 400 of the data transmission system 210 of FIG. 2. Second exemplar embodiment 400 shows a method for transmitting data between a programmable logic controller and an external network. The method 400 is called in block 402. In block 404, the method 400 receives a request for data from the external network. The request is in simple network protocol format. The request may include an OBJECTID and/or a GET command. OBJECT IDs and GET commands are common SNMP commands. The external network may be an external network such as external network 108. The request may be received by a programmable logic controller, such as programmable logic controller 102. The request may be received from an Ethernet device of the external network. After block 404, the method 400 moves to block 406.

In block 406, the method 400 inputs the request to a management information table. The management information table may be an information table such as management information table 120. The management information table is configured to translate the simple network management protocol format to an internal communication protocol format. The management information table may assign OBJECT IDs to a series of registers in the programmable logic controller. After block 406, the method 400 moves to block 408. In block 408, the method 400 translates the request to the internal communication protocol format.. The internal communication protocol may be one of the group consisting of Devicenet, Controlnet, Profinet, and Modbus TCP. After block 408, the method 400 moves to block 410.

In block 410, the method 400 retrieves the request from the management information table. After block 410, the method 400 moves to block 412. In block 412, the method 400 determines the data requested. The requested data may be stored in a register, such as register 118. The requested data may be stored in a register of the programmable logic controller in the internal communication protocol format. After block 412, the method 400 moves to block 414.

In block 414, the method 400 introduces the requested data to the management information table. The management information table is configured to translate the internal communication protocol format to simple network management protocol format. After block 414, the method 400 moves to block 416. In block 416, the method 400 translates the requested data in the internal communication protocol format the simple network management protocol format. After block 416, the method 400 moves to block 418.

In block 418, the method 400 provides the requested data to the external network. The requested data is configured to be recognized in the external network as a response to the request for data. The request data may be sent to an Ethernet device of the external network.. After block 418, the system 400 moves to block 420 and terminates.

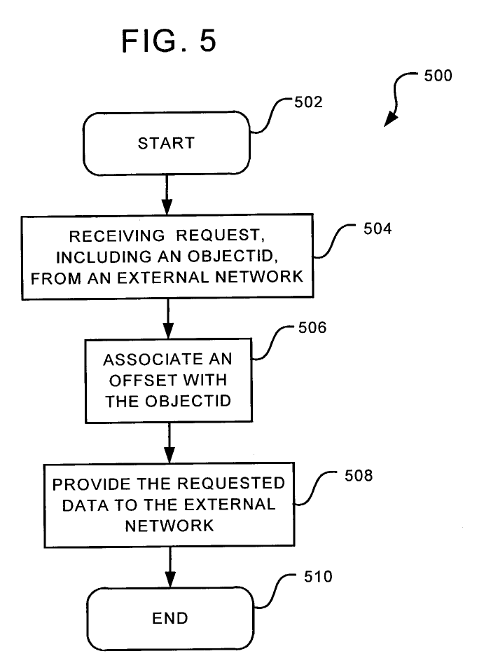

FIG. 5 is a flowchart showing a third exemplar embodiment 500 of the data transmission system 210 of FIG. 2. Third embodiment 500 shows a method for transmitting data between a programmable logic controller and an external network. For example, embodiment 500 shows a method for transmitting data from programmable logic controller 102 to external network 108. Method 500 is called in block 502. In block 504, the system 500 receives a request for data from the external network 108. The request for data is received in simple network management protocol format. The request may include an OBJECTID. After block 504, the method 500 moves to block 506.

In block 506, the method 500 associates an offset with the OBJECT ID. The offset is configured to associate the OBJECTID with a programmable logic controller register series. Such as first register 118. The register series is configured to include the requested. After block 506, the method 500 moves to block 508.

In block 508, the method 500 provides the requested data to the external network. The requested data is configured to be recognized in the external network as a response to the request for data. After block 508, the method 500 moves to block 510 and terminates.

Any process descriptions or blocks in figures, such as FIGS. 3 and 4, should be understood as representing modules, segments, or portions of code which include one or more executable instructions for implementing specific logical functions or steps in the process, and alternate implementations are included within the scope of the embodiments of the present invention in which functions may be executed out of order from that shown or discussed, including substantially concurrently or in reverse order, depending on the functionality involved, as would be understood by those having ordinary skill in the art.

It should be emphasized that the above-described embodiments of the present invention, particularly, any Apreferred@ embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

I claim:

1. A method for transmitting data between a first and a second programmable logic controller, the method comprising the steps of:
inputting data into a first register of a first programmable logic controller, the data being configured in a first network protocol, the first network protocol being determined by the communication protocol of a first internal network;
after inputting the data in the first register, inputting the data into a first management information table, the first management information table configured to translate the first network protocol to a simple network management protocol;
after inputting the data into the first management information table, transmitting the data from the first programmable logic controller to an external network;
inputting the data from the external network into a second programmable logic controller,
after inputting the data into the second programmable logic controller, inputting the data into a second management information table, the second management information table configured to translate the simple network management protocol to a second network protocol, the second network protocol being determined by the communication protocol of a second internal network; and,
introducing the data into a second register of the second programmable logic controller.

2. The method of claim 1 wherein the first network protocol and the second network protocol are incapable of facilitating direct communication between the first programmable logic controller and the second programmable logic controller.

3. The method of claim 1 wherein the housing of the first programmable logic controller houses the first management information table.

4. The method of claim 1 wherein the first programmable logic controller includes a processor, and the first management information table is configured to translate the first network protocol to a simple network management protocol by being configured to operate with the processor of the first programmable logic controller.

5. The method of claim 1 wherein a first housing of the first programmable logic controller houses the first management information table, and the second housing of the second programmable logic controller houses the second management information table.

6. A method for producing a signal for transmitting data from a programmable logic controller, the method comprising the steps of:
inputting data into a register of a programmable logic controller, the data being configured in a network protocol, the network protocol being associated with the communication protocol of an internal network, the first programmable controller having a housing;
after inputting the data in the register, inputting the data to a management information table, the management information table configured to translate the network protocol to a simple network management protocol, the management information table enclosed by the housing; and,
after inputting the data to the first management information table, transmitting a signal from the programmable logic controller to an external network, wherein the signal includes the data.

7. The method of claim 6 wherein the programmable logic controller and the external network are incapable of direct communication.

8. The method of claim 6 wherein the programmable logic controller includes a processor, and the management information table is configured to translate the network protocol to a simple network management protocol by being configured to operate with the processor of the programmable logic controller.

9. A computer readable medium for transmitting data between a programmable logic controller and an external network, comprising:
logic for receiving a request for data from the external network, wherein the request is received in simple network management protocol format, and the request is received by a programmable logic controller;
logic for inputting the request to a management information table, wherein the management information table is configured to translate the simple network management protocol format to an internal communication protocol format;
logic for retrieving the request from the management information table;
logic for determining the data requested;
logic for introducing the requested data to the management information table, wherein the management information table is configured to translate the internal communication protocol format to simple network management protocol format; and,
logic for providing the requested data to the external network, wherein the requested data is configured to be recognized in the external network as a response to the request for data.

10. The method of claim 9 wherein the logic for receiving a request for data from the external network includes logic for receiving an OBJECTID.

11. The method of claim 9 wherein the programmable logic controller and the external network are incapable of direct communication.

12. The method of claim 9 wherein the requested data is stored in a register of the programmable logic controller in the internal communication protocol format.

13. The method of claim 9 wherein the logic for receiving a request for data includes logic for communicating with an Ethernet switch.

14. The method of claim 9 wherein the logic for receiving a request for data includes logic for communicating with an Ethernet switch, and the logic for providing the requested data to the external network includes logic for communicating with the Ethernet switch..

15. The method of claim 9 wherein the logic is computer readable medium is stored in the memory of a programmable logic controller.

16. The method of claim 9 wherein the logic for receiving a request for data from the external network includes logic for receiving a GET command.

17. The method of claim 9 wherein the management information table assigns OBJECTIDs to a programmable logic controller register series.

18. A computer readable medium for transmitting data between a programmable logic controller and an external network, comprising:
logic for receiving a request for data from the external network, wherein the request is received in simple network management protocol format, the request includes an OBJECTID;
logic for associating an offset with the OBJECT ID, wherein the offset is configured to associate the OBJECTID with a programmable logic controller register series, wherein the register series is configured to include the data requested; and,
logic for providing the requested data to the external network, wherein the requested data is configured to be recognized in the external network as a response to the request for data.

19. A system network including a plurality of internal networks being operably connected to an external network, the external network being configured to transmit information according to an external communication protocol, the system network comprising:
a first programmable controller being associated with a first internal network, the first internal network employing a first communication protocol,
the first internal network including a first register and a first management information table, the first register being operably connected to the first programmable logic controller and capable of storing information received from the first programmable logic controller, the first management information table being operably connected to the first programmable logic controller and being configured to translate the first network protocol to the external communication protocol;
a second programmable controller being associated with a second internal network, the second internal network employing a second communication protocol,
the first communication protocol and the second communication protocol being diverse and incapable of facilitating direct communication between the plurality of internal networks, and,
the second internal network including a second register and a second management information table, the second register being operably connected to the second programmable logic controller and capable of storing information received from the external network, the second management information table being operably connected to the second programmable logic controller and being configured to translate the external communication protocol to the second network protocol,
wherein information can be exchanged between the plurality of internal networks.

20. The system network of claim 19 wherein the external communication network protocol is simple network management protocol (SNMP).

21. The system network of claim 19, further comprising:
the first management information table including:
a first internal network lexicon; and,
an SNMP lexicon; and,
the second management information table including:
a second internal network lexicon; and,
an SNMP lexicon.

22. The system network of claim 19, further comprising:
a computer being operably connected to the external network, the computer including a memory, the memory comprising:
a plurality of registers;
a data transmission system; and,
an operating system;
a processor; and,
an I/O device, the processor and the I/O device being operably connected to the memory via a local communication interface.

23. The system network of claim 19 further comprising:
a first processor;
a first transceiver, the first processor and the first transceiver being operably connected to the first programmable controller and cooperate to facilitate communication between the first programmable controller and the external network;
a second processor, and,
a second transceiver, the second processor and the second transceiver being operably connected to the second programmable controller and cooperate to facilitate communication between the second programmable controller and the external network.

24. The system network of claim 19 further wherein information can be exchanged between the first programmable controller and the second programmable controller.
